(19) United States
(12) Patent Application Publication
(10) Pub. No.: US 2026/0159254 A1
(43) Pub. Date: Jun. 11, 2026

(54) Method for inspecting an airplane and system

(71) Applicant: Deutsche Post AG, Bonn (DE)

(72) Inventors: Hendrik Meiner, Leipzig (DE); Benedikt Streicher, Leipzig (DE)

(21) Appl. No.: 19/180,407

(22) Filed: Apr. 16, 2025

(30) Foreign Application Priority Data
Apr. 16, 2024 (DE) 102024110611.5

(51) Int. Cl. B64F 5/60; B64F 5/40; B64U 101/26; G08G 5/32

(52) U.S. Cl. CPC B64F 5/60; B64F 5/40; B64U 2101/26; G08G 5/32

(57) ABSTRACT

A computer-implemented method for inspecting an airplane includes operating an unmanned aircraft in the area of the airplane, and during the operating capturing measurement data of the airplane by way of a sensor system of the unmanned aircraft, transmitting the measurement data to a computer device separate from the unmanned aircraft by means of a wireless communication method, and detecting at least one damaged area of the airplane on the basis of the measurement data.

The present application is based upon and claims the right of priority to DE Patent Application No. 10 2024 110 611.5, filed Apr. 16, 2024, the disclosure of which is hereby incorporated by reference herein in its entirety for all purposes.

The invention relates to a method for inspecting an airplane, comprising operating an unmanned aircraft in the area of the airplane and detecting a damaged area of the airplane. Furthermore, the invention relates to a system.

Damage to an airplane can occur in operation of the airplane. For example, damage can occur due to bird strike, lightning strikes, overuse, and/or material fatigue on the airplane. Such damage is recognizable by trained personnel, for example. Using drones having cameras in order to inspect airplanes is also known. Damage is recognized or detected in inspections in order to then remedy it. The systems or methods for inspecting an airplane known from the prior art are less automated and are susceptible to error or susceptible to malfunctions. In addition, high costs arise for carrying out inspections.

Proceeding therefrom, it is the object of the invention to provide solutions, using which the inspection of an airplane works better. The inspection of an airplane is to be able to be handled more quickly, less susceptible to error, and be able to be handled more cost-effectively, in particular at airports. In particular, it is an object of the invention to avoid or at least substantially reduce disadvantages of the prior art.

This object is achieved by the subject matter of the independent claims. Preferred refinements of the invention are found in the dependent claims.

A method is proposed for inspecting an airplane, comprising
operating an unmanned aircraft in the area of the airplane, in particular wherein the unmanned aircraft follows a flight path related to the airplane,
capturing measurement data of the airplane by way of a sensor system of the unmanned aircraft,
transmitting the measurement data to a computer device separate from the unmanned aircraft by means of a wireless communication method or a wireless communication technology, for example, LTE, 4G, 5G, mobile wireless standards developed in future, and/or WLAN, and
detecting at least one damaged area of the airplane on the basis of the measurement data. It is proposed that this is an in particular at least partially computer-implemented method.

In other words, for example, a method is specified using which an airplane can be inspected for damage, wherein an unmanned aircraft, such as a drone, is flown around the airplane, wherein—typically during this—measurement data about the airplane are generated or obtained by a sensor system of the drone, and wherein—during or after this—the measurement data are transmitted wirelessly to a computer at a distance from the drone, and wherein—during or after this—any damage on the airplane is recognized on the basis of the measurement data. The damage can be recognized by the drone itself or also the computer, for example. The damage is preferably recognized in real time, thus while the drone is still in flight.

The capturing typically takes place during the operation. The transmitting preferably takes place during the operation. The detecting preferably takes place during the operation. However, it is also possible that the transmitting and/or the detecting is/are carried out at a later time or after the operation, for example, if the wireless communication method can only communicate inadequately with the computer device. The detecting can optionally take place during the operation, in particular by means of the unmanned aircraft.

For example, the drone moves during the capturing, for example, to be able to minimize the interfering influence of reflections on the surface of the airplane or to be able to recognize these as such. In particular, it is provided that the measurement data are transmitted from the unmanned aircraft to the computer device while the unmanned aircraft is operated and/or is moving. The detecting is also to take place in operation. The method provides a high speed in the detection of the damaged area. A live or real-time recognition of damaged areas is possible.

The inspection of an airplane is to be understood generally, for example, as the recording and assessing of a technical status of the airplane. The inspection as is provided in the invention optionally includes the maintenance according to producer specification/quality features and/or specifications of air travel authorities, associations, and organizations, the cleaning, and/or the repair of the airplane.

The operation of the unmanned aircraft in the area of the airplane is to be understood in particular to mean that the unmanned aircraft flies along the airplane and/or flies in the vicinity of the airplane. In particular, the unmanned aircraft maintains an adequate safety distance from the aircraft. For example, the operation provides that the aircraft is operated spaced apart at a distance of at most 10 m, preferably at most 7.5 m, or at most 5 m, from the airplane. For example, the aircraft can be operated spaced apart at a distance of at most 3 m, preferably at most 2 m, more preferably at most 1 m, in particular at most 0.5 m, from the airplane. The operation can also include a take-off or lift-off and/or a landing and control of the unmanned aircraft.

The unmanned aircraft is in particular a drone and/or a helicopter without crew or without passengers or a multirotor or multicopter or a quadcopter, also called a quadrotor or floating platform. The drone advantageously has at least one, two, three, four, or more rotors providing lift and/or operable independently of one another as a drive. The unmanned aircraft is typically electrically operated. However, other types of drives are also possible for the unmanned aircraft. For example, an internal combustion engine or fuel-cell drive can be provided. The unmanned aircraft preferably has an energy storage device, which is in particular electrical and which can be supplied, for example, by all types of drives and/or can supply them. The electrical energy storage device is advantageously intended for feeding the sensor system with electrical energy. The unmanned aircraft typically has a control computer for controlling a/the drive of the unmanned aircraft and/or the sensor system. The control computer can be designed for transmitting and/or for detecting. The control computer or the unmanned aircraft can at least partially carry out the method.

The capturing of measurement data of the airplane relates in particular to recording the technical status of the airplane in the form of the measurement data. The measurement data thus relate to the airplane and at least indirectly and/or partially contain information about the status of the airplane. In other words, the measurement data provide a recording with respect to aspects of the status of the airplane. The measurement data regularly contain position data, image files, environmental parameters, velocity data, geometry data, weather data, time data, video data, audio data, and/or the like. Not all measurement data or all parts of the measurement data have to relate to the airplane and/or the damaged area. The measurement data can thus also have information on the unmanned aircraft, for example, on the sensor system used, on its position and/or velocity, or the like.

In particular, the sensor system provides the physical basis for the capturing. In an exemplary case, the sensor system has a camera and can capture image files and/or video data of the airplane or about the airplane using this camera. The sensor system can have devices for imaging various physical measurement principles for the capturing. The sensor system can be coupled with a/the control computer. The sensor system can be designed to carry out frequency measurements and/or can have a noise sensor.

The transmitting of the measurement data comprises all measurement data or parts of the measurement data. The transmitting can advantageously take place in real time during the operation. The transmitting optionally comprises the transmitting of the at least one damaged area, for example, when the step of detecting (at least partially or temporarily) is carried out by the unmanned aircraft. The transmitting is regularly carried out by the unmanned aircraft itself, in particular a/the control computer or a computer device of the unmanned aircraft. The transmitting implies receiving. The receiving is in particular carried out by the computer device. The computer device and the unmanned aircraft can in particular communicate with one another at least unidirectionally by way of the transmitting. Multiple unmanned aircraft can also transmit and/or receive data among one another in a group. Each aircraft can also transmit to a separate computer device and/or receive therefrom or the computer devices can be connected to one another and can transmit and receive. The computer devices can also be spatially separated from one another.

The computer device separate from the unmanned aircraft is in particular to be understood as a control centre and/or remote control for the unmanned aircraft. The computer device can at least partially trigger, control, execute, initiate, and/or monitor one or more, in particular all, method steps. The computer device can be provided in a cloud-based manner. In particular, the computer device is spatially separated from the unmanned aircraft or is at a distance therefrom at least during operation. It is not precluded in particular that the unmanned aircraft has a computer device or a control computer, for example, to temporarily store and/or process the measurement data. The computer device can provide a database for the measurement data and/or the at least one damaged area. The computer device can have, provide, or be connectable to a remote control for the unmanned aircraft, for a further unmanned aircraft, and/or for multiple (further) unmanned aircraft.

A remote control associated with the computer device can be provided, which is designed for the remote control of the unmanned aircraft, for example, for emergency operation and/or for manual control. The remote control is advantageously designed for manual operation.

The computer device being embodied with its functionalities completely or also partially on the unmanned aircraft or being provided by the unmanned aircraft can represent an independent aspect of the invention. In particular, it can be provided that a/the computer device is not provided separately from the unmanned aircraft, but rather is a component of the unmanned aircraft. The unmanned aircraft itself can insofar carry out the transmitting and/or the detecting and/or other steps. The transmitting of the measurement data can possibly also take place in a wired manner, in particular within the unmanned aircraft and/or not by means of the wireless communication method.

The wireless communication method can provide or implement a technology for data transmission. WLAN or WiFi, Bluetooth or a mobile wireless standard such as 4G, LTE, and/or 5G as well as a mobile wireless standard refined in the future can be mentioned here as examples. Data such as the measurement data and/or information on the damaged area can thus be transmitted rapidly to the computer device and/or commands can be rapidly received from the unmanned aircraft. The unmanned aircraft and the computer device are advantageously designed for carrying out the communication method or for wireless communication with one another.

Detecting the at least one damaged area of the airplane on the basis of the measurement data relates in particular to evaluating the measurement data to identify or locate damage to the airplane. While capturing provides raw data, for example, detecting provides evaluating of the raw data, for example, which gives indications of the damage to the airplane.

The sensor system can have a locating sensor, a camera, a lidar sensor, and/or a 3D sensor. At least the locating sensor and the camera are advantageously provided, and the lidar sensor and/or the 3D sensor are additionally provided. The locating sensor can provide the position of the unmanned aircraft in GPS coordinates and/or with respect to the airplane. A respective damaged area can be located in relation to the airplane by means of data provided by the locating sensor. The camera can provide image data and/or video data. The camera can have a lighting unit for illuminating the airplane. The lidar sensor is the abbreviation for a “light detection and ranging” sensor. The lidar sensor is configured for optical distance and velocity measurement and/or for remote measurement of atmospheric parameters. The lidar sensor can carry out three-dimensional laser scanning. The 3D sensor can be designed as a laser scanning sensor, similarly to the lidar sensor. The 3D sensor can be designed as a SMAT-3D sensor. SMAT stands for Structured-Light Modulation Analysis Technique. A laser image or a light image structure can be transmitted to a surface, in particular the airplane, in order to thus be able to eliminate, recognize and/or calculate out interfering reflections. The sensor system can also be designed for spectroscopy and/or laser-based material analysis. Overall, a comprehensive digital depiction of the airplane can be provided in the measurement data using the sensor system in order to detect the (at least one) damaged area therefrom reliably.

The detecting can be at least partially carried out by the unmanned aircraft. It is insofar provided that computing power is partially—or also completely—to be provided by the aircraft in order to identify or detect the damaged area. For example, if the wireless communication method only provides an inadequate connection to the computer device or only provides the connection at a location other than at the airplane itself, this design is advantageously applied. The steps of the method can be, but do not have to be, carried out chronologically or in the specified sequence. In particular the detecting can take place before the transmitting, for example, by the aircraft, and in the transmitting it can be provided that the damaged area detected by the aircraft is transmitted to the computer device in addition to the measurement data. A work division is insofar possible, for example, in order to be able to carry out the detecting promptly (in particular nearly in real time) in the case of a poor connection by means of the communication method.

It can be provided that the unmanned aircraft and the computer device are designed at least indirectly for bidirectional communication with one another by means of the wireless communication method. Insofar it is not only provided that the unmanned aircraft transmits to the computer device, but also that the computer device transmits to the unmanned aircraft. A mutual data exchange can thus take place, in particular during operation.

It is possible that the measurement data are encrypted and decrypted. Encrypting the measurement data before the transmission by the unmanned aircraft and in particular decrypting the measurement data after the transmission by the computer device can be provided. Protection against interception is thus provided.

The aircraft and/or the computer device can provide an algorithm and/or a mathematical function for the detection. The algorithm can be supplied with the measurement data, for example, and can derive or calculate the at least one damaged area therefrom. The algorithm can be adapted to the respective airplane. The algorithm can access normalized measurement data and/or the previously known measurement data, for example, to compare the measurement data with the normalized measurement data for the detecting. Normalized measurement data comprise, for example, measurement data on typical damaged areas, in particular independently of the respective airplane, for example, dents in the outer skin of an airplane which were caused by bird strike. Previously known measurement data relate, for example, to the airplane and/or the same airplane model. Previously known measurement data comprise, for example, a damage history or status history of the airplane.

The detection can take place with the aid of principles of artificial intelligence (AI) or one algorithm or multiple algorithms based thereon. The detection can be carried out by machine learning algorithms and/or deep learning algorithms and/or the use of an artificial neural network, preferably which has been trained using reference data on the airplane, in particular using (the) normalized measurement data and/or (the) previously known measurement data. The algorithm can be designed as self-learning by means of the neural network or principles of artificial intelligence (AI). With sufficient training, new, previously unknown types of damaged areas can also be automatically identified.

The detection can be categorized into at least two detection systems, having a first system in which an algorithm without principles of artificial intelligence, for example, without neural network is used, and a second system in which an algorithm having a corresponding algorithm, for example, the neural network is used. The damaged areas detected thereby are preferably classified with regard to the use of the first or the second system, so that it can be recognized whether a detected damaged area has been recognized in an AI-based or non-AI-based manner. The reliability of the neural network or the applied AI algorithms can thus be checked in the direct comparison of all damaged areas of the first and second system in order to be able to counteract incorrect detections by adapting the algorithm and also to refine or train the algorithm.

The detection can comprise a comparison of the measurement data with (the) previously known measurement data about the airplane in order to identify the damaged area in the event of a deviation (for example, between the measurement data and the previously known measurement data or the normalized measurement data). The previously known measurement data preferably relate here to precisely the same airplane as the one which was captured or at least to the same airplane model, thus a different but at least substantially structurally-identical airplane. The previously known measurement data can in particular be understood as a damage history or status history of the airplane. Ultimately, the previously known measurement data are preferably to be understood as older measurement data on the airplane. For example, warping and/or deformation of the airplane can be identified on the basis of a geometric comparison of the measurement data and the previously known measurement data, which is then detected as a damaged area.

The measurement data, as well as the previously known measurement data and/or the normalized measurement data, can comprise information about the number and/or the arrangement of stringers and/or frames of the airplane. It is possible that the drone can orient itself on model-related/design-related airplane features such as stringers and/or frames. This is because it has been shown that these features of the airplane are particularly easy to capture with little susceptibility to error sensorially as the or in the measurement data, wherein if damage is actually present on the airplane, the measurement data permit corresponding damaged areas to be identified quite easily.

The capturing, the transmission, and the detection can be carried out simultaneously. It is thus possible to work in real time as much as possible in order to detect the damaged area promptly or nearly in real time. For example, capturing can take place continuously, the measurement data can be transmitted directly, and at the same time the measurement data can be directly evaluated or detecting can take place. For example, the damaged area can be detected within an extremely short time after capturing damage, in particular seconds or minutes.

The capturing, the transmission, and the detection can be carried out in succession, in particular with chronological overlap. The capturing, the transmission, and the detection can be carried out repeatedly or can be repeated. For example, a cycle of capturing, transmitting and detecting can be repeated. For example, it is possible that initially a certain part of the airplane or the entire airplane (or the relevant areas of the airplane) is captured until the transmission is carried out. For example, initially the steps operating and capturing, preferably also the step detecting, are completed until the step transmitting is executed. It is also possible that first the capturing of the airplane is completely carried out or completed to then carry out the transmission and/or the detection.

Processing of the measurement data and storing of the measurement data and/or the damaged area in a database for damage documentation related to the airplane can be provided. The database can insofar be supplied with new previously known measurement data. The database can be provided by means of the computer device. The database can be provided in a cloud-based manner. The database can provide or have the measurement data and in particular the previously known measurement data and/or the normalized measurement data. The processing comprises, for example, smoothing and/or bandpass filtering of measurement data to remove probable measurement inaccuracies. The measurement data can be, for example, aggregated and/or filtered. Preferably, a depiction of the airplane or at least a part of the airplane is stored in the database or depicted in the form of a digital twin; these measurement data or this depiction can be used later as previously known measurement data. For a historical observation of measurement data secured against change, the measurement data can possibly be stored on a block chain. A depiction as a digital twin can take place on a/the block chain.

A categorization of the airplane in risk zones on the basis of the measurement data and/or the damaged area can be provided. The risk zones are in particular surface sections or areas of the airplane which can be captured by the unmanned aircraft. The risk zones can be stored in the database. For example, the measurement data, in particular alternatively or additionally the previously known measurement data and/or the normalized measurement data, can be evaluated in order to perform the classification into risk zones. A risk zone is distinguished in particular in that in this area of the airplane, a damaged area has existed at least once and/or a damaged area can occur with a predetermined probability. For example, a leading edge of a wing can represent a risk zone, because bird strike can increasingly occur here, which can dent or deform the surface. For example, it can be provided that the method in one variant is carried out only in relation to the risk zones, and that the method is carried out in a further variant only outside of the risk zones or is carried out in the risk zones and in further zones of the airplane differing from the risk zones.

Risk zones can result by way of producer specifications. Furthermore, dimensions of critical airplane parts can be compared over time on the basis of the various sensors as to whether change occurs here, which could indicate design-related or production-related deficiencies. These could be deformations or bulges which occur, for example, due to missing bolts or joining methods (adhesive bonding, riveting, screwing) of different materials.

In particular in addition to the unmanned aircraft, a further unmanned aircraft can be provided or operated. In the method, multiple aircraft can advantageously be operated in order to achieve a division of tasks and/or a time advantage. Energy consumption can thus also be distributed over the multiple aircraft. The (further) unmanned aircraft can be designed for marking and/or repairing the airplane, in particular a damaged area of the airplane. A marking of the damaged area by a marking device of the unmanned aircraft and/or a/the further unmanned aircraft can be provided. Repairing and/or cleaning or a cleaning operation of the damaged area, which is marked in particular, by a tool of the unmanned aircraft and/or a/the further unmanned aircraft can be provided. The (further) unmanned aircraft can insofar be designed as a marking drone and/or as a repair drone. The (further) unmanned aircraft can have, for example, an arm, in particular a gripping arm. In the marking, a damaged area can be marked optically, in particular by means of a light beam and/or laser beam, and/or by applied material, in particular by means of colour marking or the like. In the repairing, the damaged area can be mechanically repaired, in particular by means of a tool of the repair drone. The (further) unmanned aircraft, in particular the repair drone, can also be designed for cleaning, for example, of sensors, and/or for exchanging worn parts and/or for checking the functionality of components, in particular of the airplane in each case.

It is possible that one or more markings are used for distance measurements or measurements of deformations of the airplane, for example, after completing cleaning and/or repair. Distance measurements can be used as a quality feature with respect to a completed repair or possible next repairs.

Insofar as the “aircraft” or synonymously the “unmanned aircraft” is referred to in the present case, this can mean both the “unmanned aircraft” (thus in particular the one which is used for capturing) and also the “further unmanned aircraft”; this can also mean both. It is thus conceivable that optionally each of the presently mentioned aircraft or unmanned aircraft is meant in the advantageous designs of the invention described here.

Generating a model to predict a repair time of the damaged area and/or a next possible usage time of the airplane on the basis of the measurement data and/or the damaged area can be provided. Predicting a repair time of the damaged area and/or a/the next possible usage time of the airplane by means of a/the model for prediction can be provided. The method can thus provide that a prediction model is established, which establishes a prediction with respect to a repair or repair time on the basis of the damaged area or its measurement data. In particular, it is provided by means of the model for prediction that the respective detected damaged area is assigned how long a repair takes and/or how a/the repair is carried out. The repair can be provided or planned, for example, by means of the (further) unmanned aircraft or in another way. The model for prediction is, for example, a mathematical model. The generation can take place at least partially or completely in a computer-implemented manner. The generation can also take place in conjunction with experiential values or expert knowledge being input and/or requested.

Learning of the airplane can be provided. The learning can be carried out by means of the unmanned aircraft. The learning preferably takes place by capturing measurement data about the airplane. The learning is used in particular for planning a flight path related to the airplane for the aircraft and/or the further aircraft.

Furthermore, the learning is used in particular for detecting airplane damage and/or damaged areas. In particular, damaged areas can be learned. Measurement data about damaged areas from a trained algorithm or by means of AI algorithms (in particular AI model, machine learning, deep learning, and/or artificial neural network) can be used. These data can originate from different airplane models and can be used for the detection or the detecting of damaged areas with a just learned or taught airplane.

The learning can relate to a completely unknown or new model or such a type of an airplane. An airplane can be learned in which the model/type is already known (in particular in the algorithm), but in particular dedicated modifications/structures are provided and are also learned. An airplane having known model/type can be captured the first time and all damaged areas or damage of any type physically present at this time and anomalies (for example, a deformation of parts due to missing fastening, excessive strain, or the like) are detected, captured, stored, and/or classified. In particular, a digital twin of the airplane can be created.

Learning of a further airplane different from the airplane can be provided. The learning can be carried out by means of the unmanned aircraft. The learning preferably takes place by capturing measurement data about the further airplane. The learning is used in particular for planning a flight path related to the further airplane for the aircraft and/or the further aircraft. In the learning, in particular a digital twin or a depiction of the further airplane is created. For example, dimensions are determined. In other words, for example, foreign airplane models can be learned by capturing a foreign airplane. This provides autonomy of the method.

Planning of a flight path related to the airplane can be provided for the aircraft and/or the further aircraft in order to operate the aircraft and/or the further aircraft along this flight path. Planning of a flight path of the (further) unmanned aircraft can be provided. The flight path preferably relates to a course of the (further) unmanned aircraft, in particular with respect to the (further) airplane. For example, the flight path extends along the risk zones on the airplane and/or at a predetermined distance from the airplane. The flight path can also comprise information for orientation of the (further) unmanned aircraft along the flight path and/or with respect to the airplane.

In the case of a group of and/or multiple unmanned aircraft, for example, one unmanned aircraft can be present for capturing or detecting damaged areas, damage, or anomalies, which then in addition to the capturing or detecting, also transmits the measurement data or damaged areas for orientation for the other unmanned aircraft located in the group. For this purpose, an unmanned aircraft can also be provided for marking damaged areas, in particular by means of laser (for example, inscription laser), colour markings, and/or foam. A marking can thus take place permanently and/or with a time limit. All unmanned aircraft located in the group can orient themselves on the basis of markings. Markings can also be used so that a repair is carried out at a different location than where the damaged area, the damage, or the anomaly was detected/captured.

Thus, for example, an unmanned aircraft, in particular a marking drone, can also point out damage by means of a visualization (for example, light-based, in particular by means of LED) to a human (in particular a technician) in order to carry out a repair at another location (e.g., outstation, hangar, airport in another country, etc.). The location-independent repair is possible because the computer device can transfer or transmit data, on the basis of which the repair can be completed. The detection and the marking can therefore take place independently of the repair. In particular if the repair cannot be carried out using a repair drone due to the damage picture (for example, replacement of larger components is necessary), this design is expedient.

The unmanned aircraft can move in some or all internal areas of an airplane which are or can be made accessible (for example, in a cargo airplane, in a passenger airplane, and/or in a military airplane) and can capture or detect damaged areas or damage/anomalies here. Movable components of the airplane can be inspected for damage/anomalies by means of frequency measurements (for example, noise sensors), and in particular the position can be marked.

A communication, in particular during the operation and/or before the operation, with an airport control system of an airport can be provided. The communication is provided in particular for operating the unmanned aircraft and/or the further unmanned aircraft outside a hangar at the airport. In this communication, the (further) unmanned aircraft can register or reciprocate with the airport control system. The (further) unmanned aircraft can receive commands and/or obtain approvals and/or transmit identification features, in particular a location and/or an altitude of the unmanned aircraft. The communication is to enable the most automated, time-saving, and safe operation possible.

Furthermore, a system for inspecting an airplane is proposed, the system comprising an unmanned aircraft, a further unmanned aircraft, and/or a computer device, wherein the system is designed for carrying out the method described here. The system is configured in particular to carry out the method steps according to the invention.

In the context of the disclosure, the German abbreviation “bzw.” is a short form of “beziehungsweise (respectively; or; and/or)” and in principle is to indicate alternative, equivalent, and/or synonymous features or terms in order to convey the concept or the meaning of a use of a feature or term. “Bzw.” can always be replaced with “und/oder (and/or)”.

The invention is explained in more detail hereinafter on the basis of a preferred exemplary embodiment with reference to the drawings.

In the figures

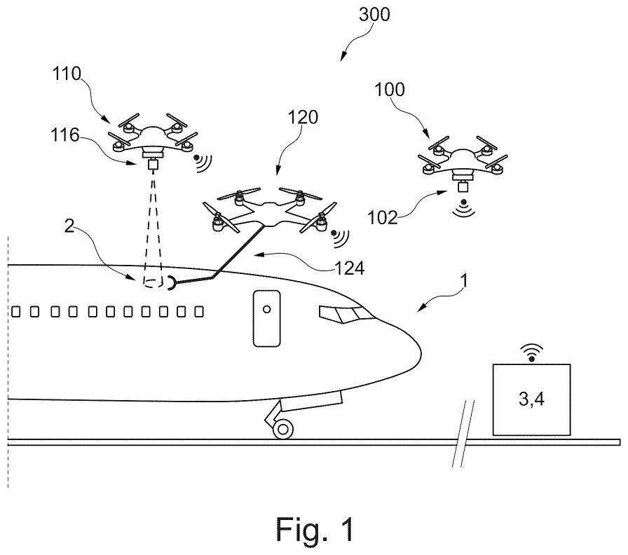

FIG. 1 shows a system for inspecting an airplane in a schematic view;

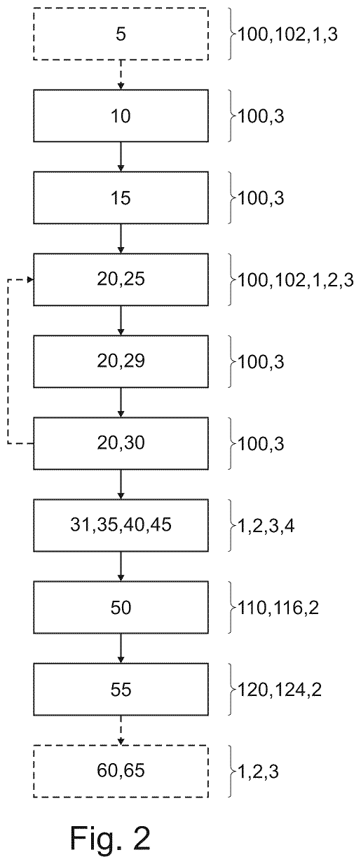

FIG. 2 shows a method for inspecting an airplane in a schematic view;

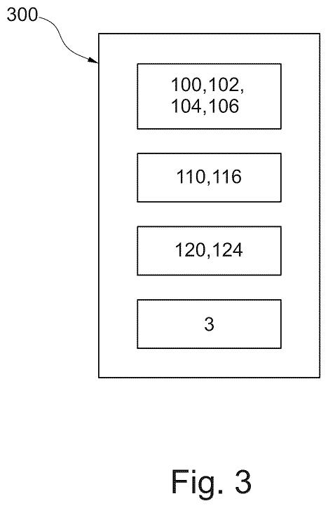

FIG. 3 shows a system for inspecting an airplane in a schematic view.

FIG. 1 shows a system 300 according to the invention for inspecting an airplane 1 at an airport. The airplane 1, of which a front section is visible, stands outside the hangar, in particular under the open sky and/or in the vicinity of the manoeuvring area. Three unmanned aircraft 100, 110, and 120 are operated at the airplane 1. The three aircraft 100, 110, 120 carry out division of work among one another, fundamentally to detect a damaged area 2 on the airplane 1 (this is done by the aircraft 100 in cooperation with a computer device 3), to mark the damaged area 2 (this is done by the further aircraft 110), and to repair the damaged area 2 (this is done by the further aircraft 120).

The aircraft 100 captures measurement data of the airplane 1 by means of a sensor system 102. The sensor system 102 comprises a positioning sensor, a camera, a lidar sensor, and a SMAT-3D sensor. The aircraft 100 can transmit the measurement data to the computer device 3. The computer device 3 can detect the damaged area 2, process the measurement data, and store the damaged area 2 and the processed measurement data in a database 3 for damage documentation. It is also possible that the aircraft 100 detects or identifies the damaged area 2 itself.

The damaged area 2 or its position on the airplane 1 can be communicated to the further unmanned aircraft 110, in particular by means of the computer device 3 and/or by means of the unmanned aircraft 100.

The further unmanned aircraft 110 can fly to the damaged area 2. The further unmanned aircraft 110 can mark the damaged area 2 by means of its marking device 116 using a laser beam and/or light beam and/or applied material, such as a colour marking.

In the present case, the further unmanned aircraft 110 projects a marking at the damaged area 2, so that the damaged area 2 is easily identifiable, in particular by the further unmanned aircraft 120.

It is alternatively or additionally possible that the further unmanned aircraft 110 and/or 120 applies a marking at the damaged area 2, for example, materials such as a colour marking and/or paint. In particular, the damaged area 2 can thus be easily identifiable, in particular by the further unmanned aircraft 120 and/or other aircraft 100, 110 and/or by personnel. For example, the marking is applied next to the damaged area 2.

The further unmanned aircraft 120 can identify the damaged area 2, which is in particular marked, and repair it using its tool 124. For example, in order to repair the damaged area 2 at least partially or to some extent, paint is sprayed onto the airplane 1, a part of the airplane 1 is exchanged, a foreign body is removed from the airplane 1, and/or the airplane 1 is cleaned.

It is alternatively or additionally possible that the marking and/or the paint is removed after the repair or the repairing and/or after the cleaning or the cleaning operation, in particular by the further unmanned aircraft 110 and/or 120 and/or by personnel. It is also possible that the marking is removed during the or by the cleaning or repair. Finally, it is also possible that the marking remains on the airplane 1, so that it can be tracked that something and/or where something was repaired or cleaned.

The repaired or cleaned damaged area 2 is stored in a database for damage documentation related to the airplane 1. An entry of the completed repair or cleaning in a computer-implemented logbook or maintenance system assigned to the airplane 1 can insofar be provided.

The computer device 3 is located outside the airplane 1, in particular in a cloud-based manner and/or as a device at the airport and/or in a central office. The computer device 3 provides the database 4. The computer device 3 communicates with all three aircraft 100, 110, and 120 and optionally with the airport control system.

It is possible that the aircraft 100, 110, and/or 120 communicate with one another, for example, to avoid collisions, to transmit measurement data, to wait for the completion of one or more method steps, in order to transmit the damaged area 2 or its position on the aircraft 1 and/or the like.

FIG. 2 shows a computer-implemented method for inspecting the airplane 1 in a schematic representation. The airplane 1 is located, for example, at an airport, cf. also FIG. 1. The airplane 1 can be located inside or outside a hangar of the airport. The method provides that an unmanned aircraft 100 is used, for example, a drone. Furthermore, a computer device 3 is provided, which is arranged separately from the unmanned aircraft 100. The method comprises a plurality of steps.

Optionally, learning 5 of the airplane 1 initially takes place to plan a flight path for the unmanned aircraft 100. The unmanned aircraft 100 captures the airplane 1 here in that it flies around the airplane 1 and captures the airplane 1 sensorially, for example, by means of a sensor system 102 of the unmanned aircraft 100. The computer device 3 can control or monitor the unmanned aircraft 100.

Optionally, learning 5 of a further airplane different from the airplane 1 takes place by capturing measurement data about the further airplane to plan a flight path related to the further airplane for the unmanned aircraft 100. For example, multiple airplane types or airplane models can be learned.

Furthermore, planning 10 of a flight path related to the airplane 1 is provided for the unmanned aircraft 100, in order to operate the unmanned aircraft 100 along this flight path. The planning 10 is preferably carried out by means of the computer device 3.

Furthermore, communicating 15 with an airport control system of the airport for operating the unmanned aircraft 100 outside the hangar at the airport is optionally provided. An approval is obtained and/or the position, velocity, and/or altitude of the unmanned aircraft 100 are reported. The communicating 15 can extend over multiple or all steps of the method and in particular takes place during operation. The communicating 15 preferably takes place by means of the computer device 3.

Furthermore, operating 20 of the unmanned aircraft 100 in the area of the airplane 1 is provided. The unmanned aircraft 100 is flown around the airplane 1, in particular along the flight path, wherein the sensor system 102 is or will be directed onto the airplane 1. The operating 20 preferably takes place with the aid of the computer device 3.

During the operating 20, capturing 25 of measurement data of the airplane 1 by the sensor system 102 takes place. The airplane is visually captured using a camera. Furthermore, the airplane is captured using a lidar sensor and/or using a SMAT-3D sensor. It is important here that all damaged areas 2 of the airplane 1 are captured or are recognizably captured in the measurement data. The damaged areas 2 are typically located on the outer skin of the airplane and/or are visible there. The damaged areas 2 can also relate to internal structures of the airplane. The measurement data contain information on the damaged areas 2.

In the step encrypting 29, the measurement data are encrypted by or on the unmanned aircraft 100. This takes place during the operating 20 of the unmanned aircraft 100. The operating preferably takes place with the aid of the computer device 3.

Subsequently, during the operating 20, transmitting 30 of the encrypted measurement data to the computer device 3 takes place by means of a wireless communication method, in particular by means of 5G mobile wireless technology. The computer device 3 receives the encrypted measurement data nearly without delay and in flight of the unmanned aircraft 100. The unmanned aircraft 100 can again continue with the step capturing 25 or return thereto. The capturing 25 can be carried out until the airplane 1 has been partially or at least approximately completely captured.

Decrypting 31 of the encrypted measurement data now takes place by means of the computer device 3. Furthermore, detecting 35 of at least one damaged area 2 of the airplane 1 on the basis of the measurement data takes place by means of the computer device 3.

The computer device 3 provides an algorithm for the detecting 35. The algorithm in particular implements principles of artificial intelligence, for example, machine learning. The algorithm has been trained using reference data on previously known damaged areas. The detecting 35 comprises a comparison of the measurement data to previously known measurement data about the airplane 1 in order to identify the damaged area 2 in the event of a deviation. The measurement data comprise information about the number and/or the arrangement of stringers and/or frames of the airplane 1.

The capturing 25, the transmitting 30, and the detecting 35 fundamentally take place simultaneously.

It is conceivable that the transmitting 30 and/or the detecting 35 are carried out following the capturing 25 or operating 20. For example, the unmanned aircraft 100 is landed after the capturing 25, for example, to end the operating 20, in order to come to the steps transmitting 30 and/or detecting 35 subsequently thereto.

In the step of processing 40, the measurement data are filtered by means of the computer device 3 and stored in a database 4 for damage documentation related to the airplane 1. In the step categorizing 45, the airplane 1 is categorized in risk zones on the basis of the measurement data and the damaged area 2.

When the operating 20 is completed, alternatively or additionally still during the operating 20, damaged areas 2 can be marked. A step of marking 50 is provided for this purpose. The marking 50 is carried out by a marking device 116 of a further unmanned aircraft 110, in particular a further drone, which emits a light beam or laser beam onto a respective damaged area 2 in order to temporarily identify it. Finally, repairing 55 and/or cleaning of the marked damaged area 2 can be carried out by a tool 124 of a further unmanned aircraft 120, in particular a further drone. Reference is made here by way of example to FIG. 3, in which the further aircraft 110 is a marking drone having the marking device 116 and the further aircraft 120 is a repair drone having the tool 124.

Furthermore, generating 60 of a model for prediction a repair time of the damaged area 2 and the closest possible usage time of the airplane 1 on the basis of the measurement data and/or the damaged area 2 can be provided. Furthermore, predicting 65 the repair time and the usage time can be carried out by means of the model for prediction. In particular, such predictions relate to damaged areas 2 which cannot be repaired by means of a repair drone. However, it is also possible that the predictions relate to damaged areas which can be repaired by means of a repair drone. The generating 60 and/or predicting 65 preferably take place with the aid of the computer device 3.

FIG. 3 shows a system 300 for inspecting an airplane. The system 300 comprises an unmanned aircraft 100, two further unmanned aircraft 110 and 120, and a computer device 3. The system 300 is designed to carry out the above-described method. The unmanned aircraft 100 has a sensor system 102, a tool 104, and a marking device 106. One of the further unmanned aircraft 110 has a marking device 116. The other one of the further unmanned aircraft 120 has a tool 124. The computer device 3 can communicate with all aircraft 100, 110, and 120 and an airport control system, in particular bidirectionally and/or in an encrypted manner.

### LIST OF REFERENCE NUMERALS

1 airplane
2 damaged area
3 computer device
4 database
5 learning
10 planning
15 communicating
20 operating
25 capturing
29 encrypting
30 transmitting
31 decrypting
35 detecting
40 processing
45 categorizing
50 marking
55 repairing
60 generating
65 predicting
100 aircraft
102 sensor system
104 tool
106 marking device
110 further aircraft
116 marking device
120 further aircraft
124 tool

1. A computer-implemented method for inspecting an airplane, comprising:
operating an unmanned aircraft in the area of the airplane,
capturing measurement data of the airplane by way of a sensor system of the unmanned aircraft,
transmitting the measurement data to a computer device separate from the unmanned aircraft by means of a wireless communication method,
detecting at least one damaged area of the airplane on the basis of the measurement data,
marking the damaged area by way of a marking device of at least one of the unmanned aircraft and a further unmanned aircraft, and
at least one of repairing and cleaning the damaged area by way of a tool of at least one of the unmanned aircraft and the further unmanned aircraft.

2. The method according to claim 1, wherein the sensor system comprises:
a locating sensor, and
at least one of a camera, a lidar sensor, and a 3D sensor.

3. The method according to claim 1, wherein the detecting is at least partially carried out by the unmanned aircraft and the at least one damaged area is then transmitted to the computer device.

4. The method according to claim 1, wherein the unmanned aircraft and the computer device are designed for bidirectional communication with one another by means of the wireless communication method.

5. The method according to claim 4, comprising:
encrypting the measurement data before the transmitting and
decrypting the measurement data after the transmitting.

6. The method according to claim 1, wherein at least one of the unmanned aircraft and the computer device provides an algorithm for the detecting.

7. The method according to the claim 6, wherein the detecting is carried out with the aid of at least one of machine learning algorithms, deep learning algorithms and the use of a neural network, which has been trained using reference data on previously known damaged areas.

8. The method according to claim 1, wherein the detecting comprises a comparison of the measurement data with previously known measurement data about the airplane, in order to identify the damaged area in the event of a deviation.

9. The method according to claim 8, wherein the capturing, the transmitting, and the detecting are carried out at least one of simultaneously and repeatedly in succession.

10. The method according to claim 1, comprising:
processing the measurement data and storing the measurement data and the damaged area in a database for damage documentation related to the airplane.

11. The method according to claim 1, comprising:
categorizing the airplane in risk zones on the basis of at least one of the measurement data and the damaged area.

12. The method according to claim 1, wherein:
the marking of the damaged area is carried out by the marking device of at least one of the unmanned aircraft and the further unmanned aircraft by applied material, and
the unmanned aircraft and the further unmanned aircraft are operated simultaneously or in succession.

13. The method according to claim 1, wherein:
the at least one of repairing and cleaning of the marked damaged area is carried out by a tool of at least one of the unmanned aircraft and the further unmanned aircraft, and
the unmanned aircraft and the further unmanned aircraft are operated simultaneously or in succession.

14. The method according to claim 1, comprising:
learning a further airplane different from the airplane by capturing measurement data about the further airplane for planning a flight path related to the further airplane for at least one of the unmanned aircraft and the further unmanned aircraft.

15. The method according to claim 1, comprising:
planning of a flight path related to the airplane for at least one of the unmanned aircraft and the further unmanned aircraft, in order to operate at least one of the unmanned aircraft and the further unmanned aircraft along this flight path.

16. The method according to claim 1, comprising:
communicating, at least one of during and before the operating, with an airport control system of an airport for operating at least one of the unmanned aircraft and the further unmanned aircraft outside a hangar at the airport.

17. A computer-implemented method for inspecting an airplane, comprising:
operating an unmanned aircraft in the area of the airplane,
capturing measurement data of the airplane by way of a sensor system of the unmanned aircraft,
transmitting the measurement data to a computer device separate from the unmanned aircraft by means of a wireless communication method,
detecting at least one damaged area of the airplane on the basis of the measurement data, wherein
the measurement data comprise information about at least one of the number and the arrangement of stringers or frames of the airplane.

18. The computer-implemented method for inspecting an airplane, comprising:
operating an unmanned aircraft in the area of the airplane,
capturing measurement data of the airplane by way of a sensor system of the unmanned aircraft,
transmitting the measurement data to a computer device separate from the unmanned aircraft by means of a wireless communication method,
detecting at least one damaged area of the airplane on the basis of the measurement data, and at least one of
generating a model for predicting at least one of a repair time of the damaged area and a closest possible usage time of the airplane on the basis of at least one of the measurement data and the damaged area, and
predicting at least one of a repair time of the damaged area and a closest possible usage time of the airplane by means of a/the model for predicting.

19. A system for inspecting an airplane, comprising at least one of an unmanned aircraft and a computer device, wherein the system is designed to carry out the method according to claim 1.

20. The system according to claim 19, comprising at least one further unmanned aircraft.
